(19) United States
(12) Patent Application Publication
(10) Pub. No.: US 2010/0124843 A1
(43) Pub. Date: May 20, 2010

(54) ELECTRONIC APPARATUS HAVING CONNECTOR WITH FUNCTION FOR PREVENTING FROM DISCONNECTING AND FASTENING AND DETACHING-PROOF DEVICE THEREOF

(75) Inventors: Yung-Hung Yang, Taoyuan Hsien (TW); Chien-Hua Chiao, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/501,558

(22) Filed: Jul. 13, 2009

(30) Foreign Application Priority Data
Nov. 17, 2008 (TW) 097144420

(51) Int. Cl. H01R 13/73

(52) U.S. Cl. 439/571

(57) ABSTRACT

An electronic apparatus having a connector with detaching-proof function used for connecting to a second connector of a power cord is disclosed. The electronic apparatus includes a body of the electronic apparatus including a housing, a first connector disposed on the housing; and a fastening and detaching-proof device disposed on the housing and adjacently to the first connector. The fastening and detaching-proof device includes a guiding device disposed on the housing, and a movable position device disposed on the housing, and guided to move back and forth between a first position and a second position by the guiding device. When the second connector is connected to the first connector, the movable position device is moved to the first position and fixed at the first position, resulting in the second connector is fastened to the first connector by the movable position device. In addition, a fastening and detaching-proof device applied in an electronic apparatus is also disclosed. The electronic apparatus includes a body including a housing and a first connector disposed in the housing for connecting to a second connector of a power cord. The fastening and detaching-proof device includes a guiding device disposed on the housing, and a movable position device disposed on the housing and guided to move back and forth between a first position and a second position by the guiding device.

### FIELD OF THE INVENTION

The present invention relates to an electronic apparatus and a fastening and detaching-proof device thereof, and more particularly to an electronic apparatus having a connector with detaching-proof function and a fastening and detaching-proof device thereof.

### BACKGROUND OF THE INVENTION

Electronic apparatus transmits power and/or signal through the connection of the electronic cord and power source or electric equipments. For example, the electronic apparatus, such as power supply device or uninterruptible power supply (UPS), needs connect to the power cord and the electric equipments, such as computer, server, medical device, internet device, communication apparatus, for transmitting power and/or signal from the electronic apparatus to the electric equipment by the power cords.

Generally, the power cord consists of a cable line and a connector. The connector is fastened and connected to one end of the cable line. The connector of the power cord is detachably connected to the corresponding outlet of the electronic apparatus. However, the connector of the power cord connected to the electronic apparatus is easily detached from the corresponding outlet because it is pulled and dragged by accidental or unexpected outside force. It causes that the power and/or signal cannot be transmitted from the electronic apparatus to the electric equipment, and the electric equipment cannot be operated, even damaged. When the electronic apparatus is an uninterruptible power supply (UPS), even though UPS can continue to supply power to the electric equipment once the power supply is abnormal or interrupted, it will still cause the electric equipment cannot be operated or even damaged if the power cord accidentally pulled from the corresponding outlet of the UPS by outside force. For example, if the electric equipment is a computer or server, it will result in the data loses or damages; if the electric equipment is a medical device for maintaining life, it could danger the patient's life once the medical device cannot be operated or damaged.

Therefore, the purpose of the present invention is to develop an electronic apparatus having a connector with detaching-proof function and a fastening and detaching-proof device thereof for preventing from disconnecting to deal with the above situations encountered in the prior art.

### SUMMARY OF THE INVENTION

An object of the present invention is to provide an electronic apparatus having a connector with detaching-proof function for preventing a connector of a power cord from accidentally or unexpectedly being pulled out to detach from the electronic apparatus. Further, it can be avoided that the power and/or signal cannot be transmitted to cause the electronic apparatus cannot be operated or even damaged.

Another object of the present invention is to provide a fastening and detaching-proof device for preventing a connector of a power cord from accidentally or unexpectedly being pulled out to detach from an electronic apparatus.

An additional object of the present invention is to provide an electronic apparatus having a connector with detaching-proof function and a fastening and detaching-proof device thereof for avoiding the power and/or signal cannot be transmitted.

According to an aspect of the present invention, there is provided an electronic apparatus having a connector with detaching-proof function, used for connecting to a second connector of a power cord. The electronic apparatus includes a body of the electronic apparatus including a housing, a first connector disposed on the housing; and a fastening and detaching-proof device disposed on the housing and adjacently to the first connector. The fastening and detaching-proof device includes a guiding device disposed on the housing, and a movable position device disposed on the housing, and guided to move back and forth between a first position and a second position by the guiding device. When the second connector is connected to the first connector, the movable position device is moved to the first position and fixed at the first position, resulting in the second connector is fastened to the first connector by the movable position device.

According to another aspect of the present invention, there is provided a fastening and detaching-proof device applied in an electronic apparatus. The electronic apparatus includes a body and a first connector. The body includes a housing and the first connector is disposed in the housing for connecting to a second connector of a power cord. The fastening and detaching-proof device includes a guiding device disposed on the housing, and a movable position device disposed on the housing and guided to move back and forth between a first position and a second position by the guiding device. When the second connector is connected to the first connector, the movable position device is moved to the first position and fixed at the first position, resulting in the second connector is fixed to the first connector by the movable position device.

### BRIEF DESCRIPTION OF THE DRAWINGS

The present invention may best be understood through the following description with reference to the accompanying drawings, in which:

FIG. 1 is a diagram illustrating a preferred embodiment of an electronic apparatus having a connector with detaching-proof function according to the present invention;

FIG. 2 is a partial enlarged structure diagram illustrating the electronic apparatus having a connector with detaching-proof function of FIG. 1 and a power cord;

FIG. 3 is a structure diagram illustrating a guiding device of the fastening and detaching-proof device of FIG. 2;

FIGS. 4A and 4B are elevation view and bottom view diagrams illustrating a movable position device of the fastening and detaching-proof device of FIG. 2; and

FIGS. 5A and 5B are diagrams illustrating the movable position device of the fastening and detaching-proof device of FIG. 2 at the first position A and the second position B, respectively.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

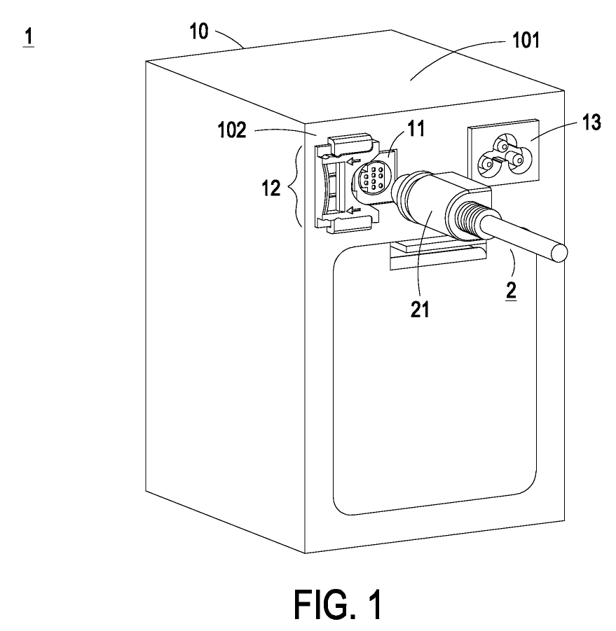

FIG. 1 is a diagram illustrating a preferred embodiment of an electronic apparatus having a connector with detaching-proof function according to the present invention. The electronic apparatus having a connector with detaching-proof function can be a power supply device or an uninterruptible power supply (UPS), such as a direct current uninterruptible power supply (DCUPS), but it is not limited to. The electronic apparatus 1 according to the present invention can prevent a power cord 2 from detaching thereto when connecting to the power cord 2. As shown in FIG. 1, the electronic apparatus 1 includes a body 10, a first connector 11 and a fastening and detaching-proof device 12. The body 10 includes a housing 101 and a power supply circuit (not shown in FIG. 1), wherein the housing 101 includes a first surface 102 and the power supply circuit disposed inside of the housing 101. The first connector 11 is disposed on the first surface 102 of the housing 101 and connected to the power supply circuit (not shown in FIG. 1). The fastening and detaching-proof device 12 is disposed on the first surface of the housing 101 and adjacent to the first connector 11 for preventing the second connector 21 of the power cord 2 from detaching from the first connector 11 of the electronic apparatus 1 when the second connector 21 is connected to the first connector 11. In some embodiments, the body 10 further includes a power socket 13, such as power input socket, and an energy-storage device (not shown in FIG. 1) such as battery. Furthermore, the power socket 13 and the energy-storage device are respectively connected to the power supply circuit.

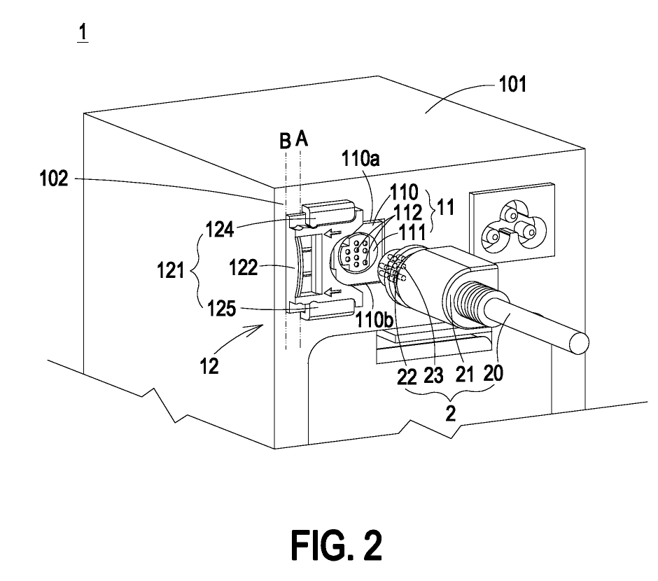

Please refer to FIG. 2 which is a partial enlarged structure diagram of the electronic apparatus having a connector with detaching-proof function of FIG. 1 and a power cord. The first connector 11 of the electronic apparatus 1 according to the present invention can be a power socket, but it is not be limited to. The first connector 11 includes a connector body 110, a socket 111 and a plurality of conductive elements 112. The connector body 110 is embedded in the first surface 102 of the housing 101 and the plural conductive elements 112 are disposed in the socket 111. The power cord 2 includes a cable line 20 and the second connector 21. The second connector 21 is connected and fixed to one end of the cable line 20. The second connector 21 further includes a clipping portion 22 and a plurality of conductive elements 23. The clipping portion 22 can be a fillister disposed surround the second connector 21, but it is not be limited to. Furthermore, the plural conductive elements 23 are disposed at one end of the second connector 21 for conducting and connecting to the plural conductive elements 112 of the first connector 11 of the electronic apparatus 1.

Please refer to FIG. 2. The fastening and detaching-proof device 12 includes a guiding device 121 and a movable position device 122. The guiding device 121 includes a first guiding component 124 and a second guiding component 125. The first and second guiding components 124 and 125 are disposed on the first surface 102 of the housing 101, at two opposite sides 110a and 110b of the body 110 of the first connector 11, and adjacently to the body 110 of the first connector 11. The movable position device 122 can be a movable positioning board, but not be limited to. As shown in FIG. 2, the movable position device 122 is disposed on the first surface 102 of the housing 101, and can be moved between a first position A and a second position B by the guiding device 121. When the second connector 21 of the power cord 2 is connected to the first connector 11, the movable position device 122 can be moved and fixed to the first position A for fastening and positioning the second connector 21 of the power cord 2 to the first connector 11 and avoiding the second connector 21 of the power cord 2 to detach from the first connector 11. On the other hand, when the second connector 21 of the power cord 2 is desired to detach from the first connector 11, the movable position device 122 can be moved and fixed to the second position B for pulling the second connector 21 of the power cord 2 out the first connector 11.

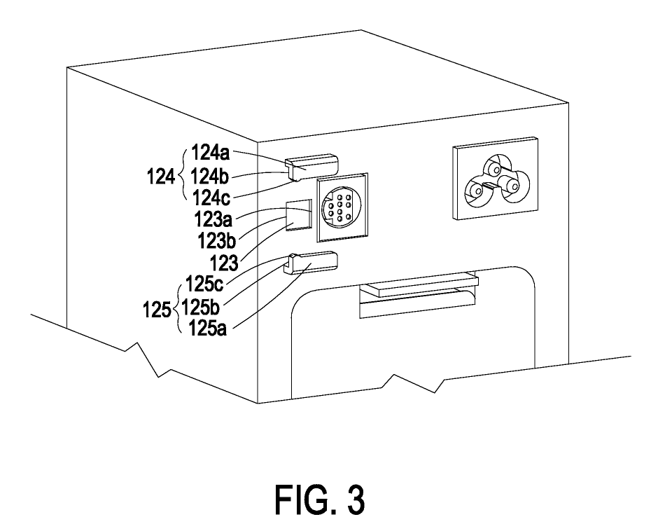

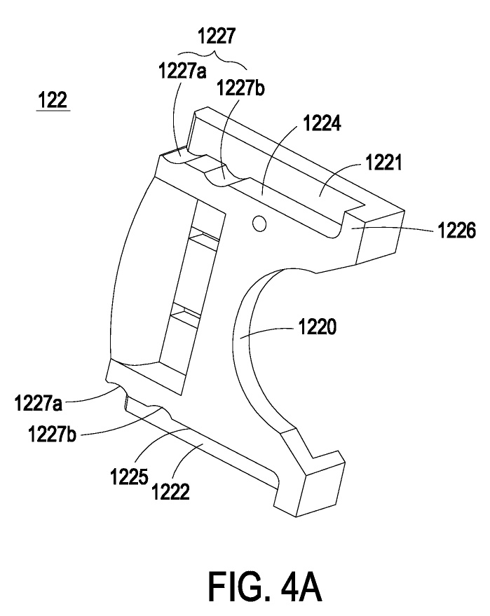

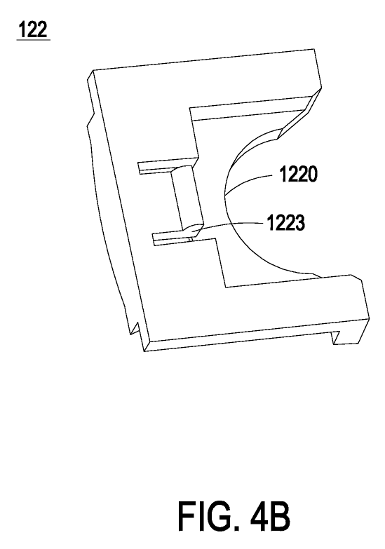

FIG. 3 is a structure diagram illustrating a guiding device of the fastening and detaching-proof device of FIG. 2. FIGS. 4A and 4B are elevation view and bottom view diagrams illustrating a movable position device of the fastening and detaching-proof device of FIG. 2. As shown in FIGS. 2, 3, 4A and 4B, the first and second guiding components 124 and 125 are constructed of substantially L-type extending parts 124a and 125a, respectively, to form a first and a second guiding slots 124b and 125b, respectively. Preferably, the extending parts 124a and 125a are integrally formed with the first surface 102 of the housing 101. Moreover, the extending parts 124a and 125a respectively have locking portions 124c and 125c. The locking portions 124c and 125c are respectively disposed at one side of the extending parts 124a and 125a, and opposite side of the first connector 11.

Please refer to FIGS. 4A and 4B. The movable position device 122 includes a positioning portion 1220, a first slideway portion 1221, a second slideway portion 1222 and a holding portion 1223. The positioning portion 1220 is corresponded to the clipping portion 22 of the second connector 21 of the power cord 2. Hence, when the second connector 21 is connected to the first connector 11, the positioning portion 1220 of the movable position device 122 is engaged to the clipping portion 22 of the second connector 21 for fixing the second connector 21 on the first surface 102 of the housing 101 and limiting the second connector 21 to move in the vertical direction to the first surface 102 of the housing 101. In some embodiments, the positioning portion 1220 of the movable position device 122 is an indentation arc lateral region, but it is not limited to. Furthermore, the clipping portion 22 of the second connector 21 of the power cord 2 is a fillister which cooperated with the positioning portion 1220 for engaging the clipping portion 22 to the positioning portion 1220.

In addition, the first slideway portion 1221 and the second slideway portion 1222 are outward extended from two opposite sides of the movable position device 122, the first lateral side 1224 and the second lateral side 1225, respectively. The first and second slideway portions 1221 and 1222 are cooperated with the first and second guiding components 124 and 125, respectively, for moving the movable position device 122 between the first position A and the second position B. In this embodiment, the first and second slideway portions 1221 and 1222 of the movable position device 122 are disposed in the first guiding slot 124b of the first guiding component 124 and the second guiding slot 125b of the second guiding component 125 of the guiding device 121, respectively, but it is not limited to.

In this embodiment, the movable position device 122 further includes a buckling device 1227 disposed at the first lateral side 1224 and/or the second lateral side 1225. The buckling device 1227 can be multi-stage buckling, but it is not limited to, and includes a first buckling region 1227a and a second buckling region 1227b. The locking portion 124c of the first guiding component 124 and/or the locking portion 125c of the second guiding component 125 of the guiding device 121 are corresponded to the positions of buckling device 1227, and can be moved between the first buckling region 1227a and the second buckling region 1227b for optionally locking with one of two regions to fasten the movable position device 122 at the first position A or the second position B.

Please refer to FIG. 3. The fastening and detaching-proof device 12 further includes a first spacing device 123 for limiting the moving range of the movable position device 122. The first spacing device 123 is disposed on the first surface 102 of the housing 101 and between the first and second guiding components 124 and 125 of the guiding device 121, and is adjacent to the first connector 11. The first spacing device 123 can be an indentation, but it is not limited to. Preferably, the first spacing device 123 is integrally formed with the first surface 102 of the housing 101.

Please refer to FIGS. 3, 4A and 4B. The holding portion 1223 is disposed at the bottom of the movable position device 122 and corresponded to the first spacing device 123 of the first surface 102 of the housing 101. Hence, when the second connector 21 of the power cord 2 is connected to the first connector of the electronic equipment 1, the movable position device 122 can be moved to the first position A to engage the positioning portion 1220 with the clipping portion 22 of the power cord 2, resulting in that the holding portion 1223 of the movable position device 122 is against to the first lateral side 123a of the first spacing device 123 for fixing the movable position device 122 at the position A to avoid moving. On the other hand, when the second connector 21 of the power cord 2 is desired to disconnect with the first connector 11 of the electronic equipment 1, the movable position device 122 can be moved to the second position B for detaching the clipping portion 22 of the power cord 2 from the positioning portion 122. That is, the holding portion 1223 of the movable position device 122 is against to the second lateral side 123b of the first spacing device 123 for limiting the moving of the movable position device 122. In some embodiments, the holding portion 1223 can be an elastic hook or protruding piece, but it is not limited to.

In addition, in some embodiments, the movable position device 122 further includes a second spacing device 1226 disposed at one end of the first slideway portion 1221 and/or the second slideway portion 1222 and extended upward from the end. When the movable position device 122 is moved to the second position B to detach the positioning portion 1220 from the clipping portion 22 of the power cord 2, the second spacing device 1226 of the movable position device 122 can be against to the lateral side of the first guiding component 124 and/or the second guiding component 125 of the guiding device 121 for limiting the movement of the movable position device 122.

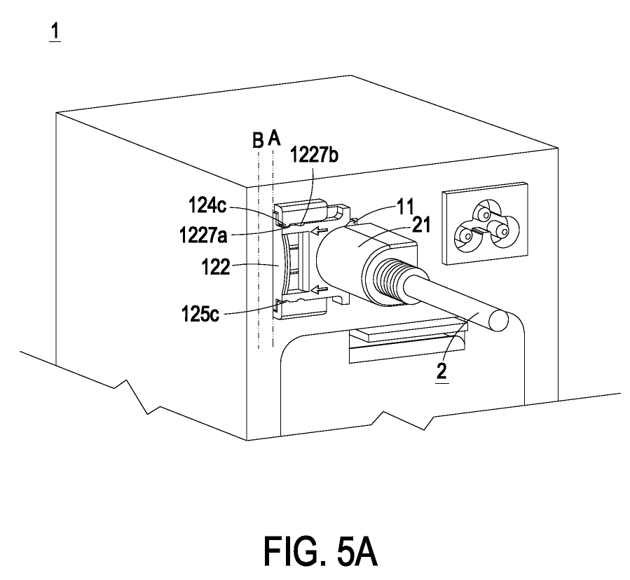

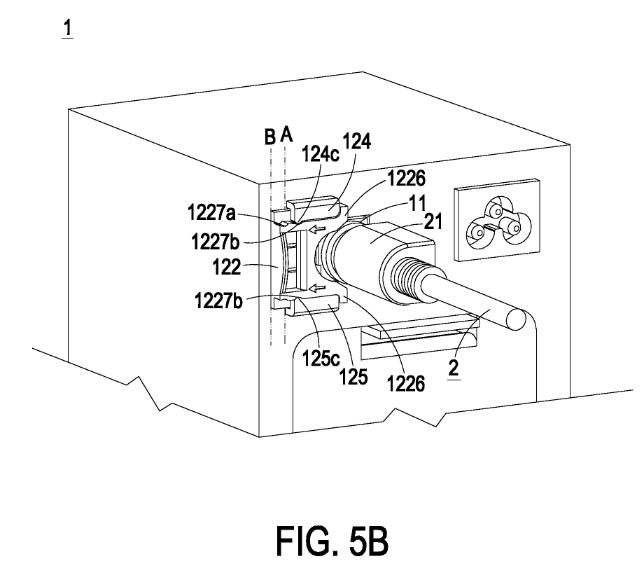

Please refer to FIGS. 5A and 5B which are diagrams illustrating the movable position device of the fastening and detaching-proof device of FIG. 2 at the first position A and the second position B, respectively. As shown in FIGS. 2, 3, 4A, 4B and 5A, when the second connector 21 of the power cord 2 is connected to the first connector 11, the movable position device 122 can be moved to the first position A and the positioning portion 1220 of the movable position device 122 is buckled to the clipping portion 22 of the power cord 2, for fixing the second connector 21 of the power cord 2 to the first connector 11 and avoiding separation. In addition, the first buckling region 1227a of the buckling device 1227 of the movable position device 122 is locked to the locking portions 124c and/or 125c of the body 10, for fixing the movable position device 122 at the position A. Moreover, the holding portion 1223 of the movable position device 122 is against to the first lateral side 123a of the first spacing device 123, for avoiding the movable position device 122 moving toward the direction of the second connector 21 of the power cord 2.

Please refer to FIGS. 2, 3, 4A, 4B and 5B. When the second connector 21 of the power cord 2 is desired to disconnect to the first connector 11, the movable position device 122 can be moved to the second position B and the clipping portion 22 of the power cord 2 is detached from the positioning portion 1220 of the movable position device 122, for pulling out the second connector 21 of the power cord 2 from the first connector 11. In addition, the second buckling region 1227b of the buckling device 1227 of the movable position device 122 is locked to the locking portions 124c and/or 125c of the body 10, for fixing the movable position device 122 at the second position B. Moreover, the holding portion 1223 of the movable position device 122 can be against to the second lateral side 123b of the first spacing device 123 of the body 10, and/or the second spacing device 1226 of the movable position device 122 can be against to the lateral sides of the first guiding component 124 and/or the second guiding component 125, for avoiding the movable position device 122 moving toward the direction far away from the second connector 21 of the power cord 2.

To sum up, the electronic apparatus of the connector having a detaching-proof function according to the present invention can prevent a power cord from disconnecting to the electronic apparatus by a fastening and detaching-proof device when the power cord is connected thereto. Hence, the disadvantage that the connector of the power cord can be accidentally or unexpectedly pulled out according to the prior art can be solved. Further, it can be avoided that the power and/or signal cannot be transmitted to cause the electronic apparatus cannot be operated or even damaged.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic apparatus having a connector with detaching-proof function, used for connecting to a second connector of a power cord, comprising:
a body of said electronic apparatus including a housing;
a first connector disposed on said housing; and
a fastening and detaching-proof device disposed on said housing and adjacently to said first connector, and comprising:
a guiding device disposed on said housing; and
a movable position device disposed on said housing, and guided to move back and forth between a first position and a second position by said guiding device,
wherein when said second connector is connected to said first connector, said movable position device is moved to said first position and fixed at said first position, resulting in said second connector is fastened to said first connector by said movable position device.

2. The electronic apparatus having a connector with detaching-proof function according to claim 1 wherein said electronic apparatus is one of a power supplier and an uninterruptible power supply.

3. The electronic apparatus having a connector with detaching-proof function according to claim 1 wherein said housing has a first surface and said first connector and said fastening and detaching-proof device are disposed thereon.

4. The electronic apparatus having a connector with detaching-proof function according to claim 1 wherein said first connector is power output socket.

5. The electronic apparatus having a connector with detaching-proof function according to claim 1 wherein said first connector comprises a body, a socket and a plurality of conductive elements, said body is inserted in said housing and said plural conductive elements are disposed inside of said socket.

6. The electronic apparatus having a connector with detaching-proof function according to claim 1 wherein said power cord further comprises a clipping portion disposed on said second connector.

7. The electronic apparatus having a connector with detaching-proof function according to claim 6 wherein said movable position device further comprises a positioning portion corresponding to said clipping portion, for engaging said positioning portion of said movable position device with said clipping portion of said power cord to fasten said second connector to said first connector when said second connector is connected to said first connector and said movable position device is moved to said first position, and for detaching said positioning portion of said movable position device from said clipping portion of said power cord when said movable position device is moved to said second position.

8. The electronic apparatus having a connector with detaching-proof function according to claim 7 wherein said positioning portion of said movable position device is an arc lateral region and said clipping portion of said power cord is a fillister.

9. The electronic apparatus having a connector with detaching-proof function according to claim 1 wherein said fastening and detaching-proof device further comprises a first spacing device disposed on said housing and adjacent to said first connector and said guiding device, and said movable position device further comprises a holding portion disposed on the bottom side and is against to said first spacing device.

10. The electronic apparatus having a connector with detaching-proof function according to claim 9 wherein said first spacing device is an indentation portion having a first lateral side and a second lateral side, and said holding portion is one of an elastic hook and a protruding piece to be against to said first and second lateral sides.

11. The electronic apparatus having a connector with detaching-proof function according to claim 1 wherein said guiding device comprises a first guiding component and a second guiding component, said first and second guiding components are disposed on said housing opposite to each other and respectively adjacent to two opposite lateral sides of said first connector, and said movable position device further comprises a first slideway portion and a second slideway portion respectively cooperating with said first and second guiding components, whereby said movable position device is moved between said first position and said second position.

12. The electronic apparatus having a connector with detaching-proof function according to claim 11 wherein said first and second guiding components are a first guiding slot and a second guiding slot of extending parts, respectively, and said first and second slideway portions of said movable position device are extended outward from two opposite sides, a first lateral side and a second lateral side.

13. The electronic apparatus having a connector with detaching-proof function according to claim 11 wherein said movable position device further comprises a second spacing device disposed at one end of said first and/or second slideway portions and expended upward, for being against lateral walls of said first and/or second guiding components of said guiding device.

14. The electronic apparatus having a connector with detaching-proof function according to claim 1 wherein said fastening and detaching-proof device further comprising:
a locking portion disposed on said housing; and
a buckling device disposed on said movable position device, for locking with said locking portion to fix said movable position device at said first or second position.

15. The electronic apparatus having a connector with detaching-proof function according to claim 14 wherein said locking portion is disposed on said guiding device and corresponding to said buckling device.

16. The electronic apparatus having a connector with detaching-proof function according to claim 15 wherein said buckling device is disposed at a first and/or a second lateral sides of said movable position device.

17. The electronic apparatus having a connector with detaching-proof function according to claim 16 wherein said buckling device includes a first buckling region and a second buckling region, and said locking portion corresponded to said buckling device's location is movable between said first buckling region and said second buckling region and is alternatively locked to one of said first and second buckling regions for fixing said movable position device to said first position or said second position.

18. The electronic apparatus having a connector with detaching-proof function according to claim 17 wherein said first buckling region of said buckling device of said movable position device is locked to said locking portion of said body, resulting in said movable position device is fixed at said first position.

19. The electronic apparatus having a connector with detaching-proof function according to claim 17 wherein said second buckling region of said buckling device of said movable position device is locked to said locking portion of said body, resulting in said movable position device is fixed at said second position.

20. A fastening and detaching-proof device applied in an electronic apparatus, wherein said electronic apparatus comprises a body and a first connector, said body includes a housing and said first connector is disposed in said housing for connecting to a second connector of a power cord, said fastening and detaching-proof device comprising:
a guiding device disposed on said housing; and
a movable position device disposed on said housing, and guided to move back and forth between a first position and a second position by said guiding device,
wherein when said second connector is connected to said first connector, said movable position device is moved to said first position and fixed at said first position, resulting in said second connector is fixed to said first connector by said movable position device.
